(19) United States
(12) Patent Application Publication
(10) Pub. No.: US 2009/0121573 A1
(43) Pub. Date: May 14, 2009

(54) Motor for electric power steering apparatus

(76) Inventor: Hirotatsu Ikeno, Gunma (JP)

Correspondence Address: WENDEROTH, LIND & PONACK, L.L.P., 1030 15th Street, N.W.,, Suite 400 East, Washington, DC, 20005-1503, US

(21) Appl. No.: 11/990,840

(22) PCT Filed: Aug. 29, 2006
(86) PCT No.: PCT/JP2006/316968

§ 371 Date: Feb. 22, 2008

(30) Foreign Application Priority Data
Sep. 7, 2005 (JP) 2005-258867

(51) Int. Cl. H02K 21/14

(52) U.S. Cl. 310/195

(57) ABSTRACT

[PROBLEMS] To provide a motor for EPS which can exhibit a desired performance while satisfying severe limitation on physical size.

[MEANS FOR SOLVING PROBLEMS] In a motor for a rack assist type electric power steering system arranged coaxially around a rack shaft coupled with a steering wheel and supplying a steering assist force to the rack shaft, the motor has a six-pole, nine-slot structure and the loading ratio (2PΦ/(ZI/a)) of its magnetic loading (2PΦ) to electric loading (ZI/a) is set in the range of 100-300. Consequently, a motor for EPS in which physical size, output, steering feeling, cost, and the like, are satisfied in good balance can be obtained. Since a numeric value conforming to EPS specification is set for the loading ratio, specification at each part of the motor can be determined in accordance with that value, resulting in optimization of design or reduction in manhour of design.

### TECHNICAL FIELD

The present invention relates to a motor used as a driving source in electric power steering apparatuses, more particularly, the invention relates to a technique that is useful when applied to an electric power steering apparatus of rack-assist type in which a rack shaft of a vehicle is inserted into the center part of the motor.

### BACKGROUND ART

In recent years, a so-called power steering apparatus has been used in many vehicles, assisting the steering force of vehicle wheels such as automobiles. At present, more and more vehicles have an electrically driven steering apparatus (so-called electric power steering apparatus), in order to reduce the load on the engine or decrease the weight of the vehicle and the like. The electric power steering apparatus (hereinafter abbreviated to EPS) is generally applied to a rack-and-pinion type steering apparatus and EPSs now available are classified roughly into three types, in accordance with the motor position. Namely, from the side near a driver, the three types such as the column assist type in which the motor is arranged on the steering shaft; the pinion assist type in which the motor is arranged at the junction between the steering shaft and the rack shaft; and the rack assist type in which the motor is arranged coaxial with the rack shaft are known.

EPS disclosed in Patent Document 1 is an apparatus of rack assist type, in this apparatus, the motor arranged coaxial with the rack shaft exerts a steering assist force. FIG. 3 is a sectional view showing the configuration of such a rack assist type EPS as is disclosed in Patent Document 1. In the EPS 51 of FIG. 3, the motor 53 arranged coaxial with the rack shaft 52 generates a steering assist force, and this force is transmitted to the rack shaft 52 by a ball-screw mechanism 54. The rack shaft 52 is linked, at the both ends thereof, to a steering control wheel by a tie rod (not shown), a knuckle arm (not shown) and the like, and also coupled to a steering shaft 55 by way of a rack-and-pinion gear. The rack shaft 52 is moved in its axial direction (to the left or the right, in FIG. 3) as the driver operates the steering wheel. The motor 53 has a cylindrical yoke 56, a magnet 57, a cylindrical rotor shaft 58 and a rotor core 59, the magnet 57, rotor shaft 58 and rotor core 59 are coaxially inserted in the yoke 56 and the rack shaft 52 is inserted in the rotor shaft 58.

In the EPS 51, when the steering shaft 55 rotates as the steering wheel is rotated, the rack shaft 52 moves to the direction in accordance with the rotation to perform the steering operation. Activating a steering torque sensor (not shown) by the operation, appropriate power is supplied to the motor 53 based on the detected torque. When the motor 53 is thereby driven, the ball-screw mechanism 54 transmits the rotation of the motor to the rack shaft 52. In other words, the ball-screw mechanism 54 converts the rotation of the motor 53 to an axial motion of the rack shaft 52, a steering assist force is given to the rack shaft 52. The steering control wheels are turned by the steering assist force and manual steering force to reduce steering loads of the driver.

Patent Document 1: Jpn. Pat. Appln. Laid-Open Publication No. 10-152058
Patent Document 2: Jpn. Pat. Appln. Laid-Open Publication No. 2004-180449

### DISCLOSURE OF THE INVENTION

### Problems to be Solved by the Invention

On the other hand, in most cases, a strict limitation is imposed on the physical size (particularly, the outer dimensions) of such a rack assist type EPS as shown in FIG. 3 so that the EPS may be laid out compact (thin and short) in the engine room. An EPS for use in, for example, small cars, is commercially unsuccessful if its outside diameter exceeds 100 mm, the motor should therefore satisfy optimal specification so that its outside diameter may be 100 mm or less. On the other hand, the rack shaft itself that passes through the motor has an outside diameter of about 20 to 30 mm, the rotor shaft, in which the rack shaft is inserted, should therefore has an inside diameter of about 20 to 40 mm. Accordingly, the outside diameter of any motor for the lack assist type EPS should be 100 mm or less, though the rack shaft lies, extending in the center part, further, it is demanded that the motor should have a desired output with the limited size, and low friction, low torque ripple and low cost are required.

However, to determine the specification of a motor for the EPS that can be small, perform well and be manufactured at low cost, very complex and intricate design adjustments are required. More specifically, various parameters concerning the magnets and windings are involved in structural designing such a motor, and many of them are in trade-off relation. In many cases, it is difficult, even for skilled and experienced designers, to determine the specification of a motor, which satisfies all requirement described above, therefore, some design guidelines are required that would help the designers to provide the optimal motor easily.

An object of the present invention is to design a motor for the EPS easily, which can bring out desired performance as to output, cogging torque, torque ripple and the like, while satisfying the dimensional restriction imposed on it.

### Means for Solving the Problems

A motor for use in an electric power steering apparatus, according to the present invention, is configured to be mounted on, and arranged coaxial with, a rack shaft coupled to a steering wheel. The load ratio (2PΦ/(ZI/a)) showing the ratio of the magnetic load (2PΦ) of the motor to the electric load (ZI/a) thereof is 100 to 300.

In the present invention, since the load ratio is 100 to 300, it is possible to obtain an EPS motor that satisfies items of requirements such as size, output, feeling of steering and cost, in a well-balanced manner. Further, if the design specification of the components of the motor is determined in accordance with the numerical value specified above, the specification setup of the motor will be fit for the EPS.

In the motor for use in the electric power steering apparatus, the ratio between the number of turns and the wire diameter may preferably be set in the range of 18 to 22. Further, the motor for use in the electric power steering apparatus may be a brushless motor that has six-pole, nine-slot.

The motor may have a stator comprising a housing, a stator core secured to an inner circumferential surface of the housing, and a winding wound around the stator core; and a rotor comprising a hollow-cylindrical rotor shaft in which the rack shaft of the steering apparatus is inserted, a hollow-cylindrical rotor core mounted on an outer circumferential surface of the rotor shaft, a magnet mounted on an outer circumferential surface of the rotor core, and a magnet cover fitted on the outside of the magnet. In this case, the above-described outside diameter may range from 85 mm to 100 mm.

### ADVANTAGES OF THE INVENTION

The motor for use in an electric power steering apparatus, according to the present invention, is configured to be mounted on, and arranged coaxial with, a rack shaft coupled to a steering wheel and since the load ratio showing the ratio of the magnetic load the electric load of the motor is 100 to 300, it is possible to obtain a suitable EPS motor that satisfies items of requirements such as size, output, suppressed heat generation, feeling of steering and cost, in a well-balanced manner. Further, it is possible to obtain a specification setup fit for the EPS concerning the load ratio, which is one of the parameters that poses a problem in designing the motor structure, if the specification of each part of the motor is determined according to said value, thus, the optimal design of the motor for EPS can be attained. Moreover, since the number of designing steps can be reduced, the cost of developing the product can be reduced and the cost of the product can be also lowered.

### BRIEF DESCRIPTION OF THE DRAWINGS

FIG. 1 is a sectional view showing a motor for EPS according to the present invention;

FIG. 2 is an explanatory diagram showing the relation between the ratio of the number of turns and the wire diameter, the resistance of the motor and the length of the magnet circuit; and

FIG. 3 is a sectional view showing an EPS of rack assist type.

### EXPLANATION OF REFERENCE SYMBOLS

| | |
|---|---|
| 1: | Motor |
| 2: | Lack shaft |
| 3: | Ball-screw mechanism |
| 11: | Stator |
| 12: | Housing |
| 13: | Stator core |
| 14: | Winding |
| 15: | Power supplying wires |
| 21: | Rotor |
| 22: | Rotor shaft |
| 23: | Rotor core |
| 24: | Magnet |
| 25: | Magnet cover |
| 31: | Housing |
| 32: | Bearing |
| 33: | Resolver |
| 34: | Resolver stator |
| 35: | Resolver rotor |
| 36: | Coil |
| 41: | Housing |
| 42: | Nut section |
| 43: | Screw section |
| 44: | Ball |
| 45: | Angular bearing |
| 46a, 46b: | Bearing-holding ring |
| 47: | Stepped section |
| 48: | Bearing-holding ring |
| 49. | Stepped section |
| 51: | Electric power steering apparatus |
| 52: | Rack shaft |
| 53: | Motor |
| 54: | Ball-screw mechanism |
| 55: | Steering shaft |
| 56: | Yoke |
| 57: | Magnet |
| 58: | Rotor shaft |
| 59: | Rotor core |
| M: | load ratio |
| P: | The number of poles |
| Φ: | Effective magnetic flux per pole |
| Z: | The number of effective conductors |
| I: | Effective value of rated phase-current |
| a: | The number of parallel circuits/2 |
| S: | The number of slot |
| T: | The number of winding |

### BEST MODE FOR CARRYING OUT THE INVENTION

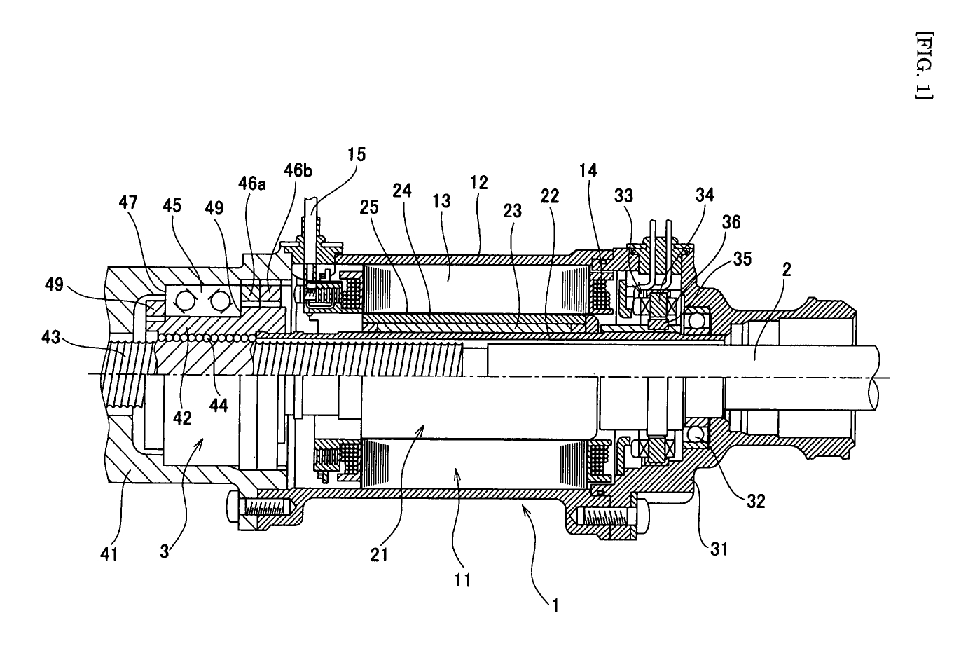

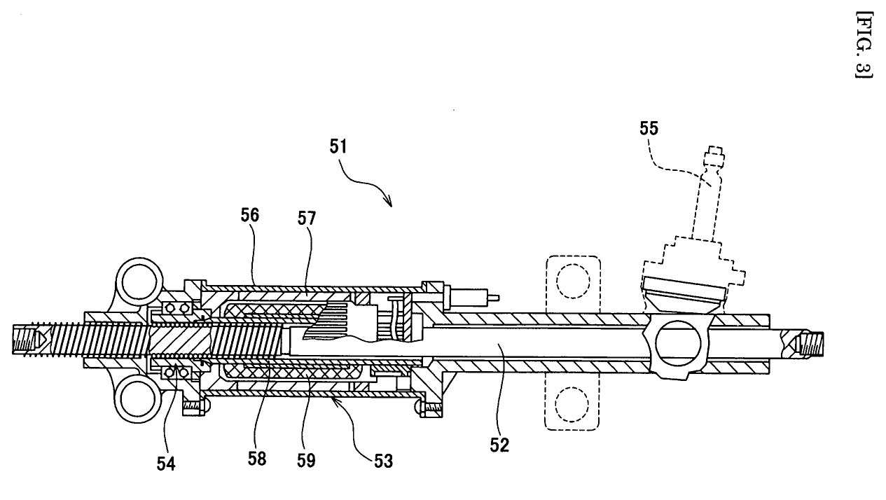

An embodiment of the present invention will be described with reference to the accompanying drawings. FIG. 1 is a sectional view showing the configuration of a motor for EPS, according to the present invention. The motor 1 of FIG. 1 is used as driving source for use in such a rack assist type EPS as shown in FIG. 3, and a rack shaft 2 passes through the inside of the motor 1. The motor 1 of FIG. 1 is a brushless motor, unlike the motor 53 of FIG. 3, the rotation of the motor 1 is transmitted to the rack shaft 2 by a ball-screw mechanism 3 so as to be a steering assist force.

The motor 1 has an inner rotor type structure, comprising a stator 11 outside and a rotor 21 inside. The stator 11 comprises a housing 12, a stator core 13 secured to an inner circumferential side of the housing 12, and a winding 14 wound around the stator core 13. The housing 12 is made of iron etc. and an outside diameter thereof is kept at 100 mm or less. The stator core 13 is composed of many steel plates laid one on another, and a plurality of teeth (nine, in this embodiment) protrude from the inner circumferential side of the stator core 13. A plurality of slots (nine, in this embodiment) are provided between the teeth, and a coil is wound around the slot formed between the teeth, to form the winding 14. The winding 14 is connected to a battery (not shown) via power supplying wires 15.

The rotor 21 is arranged inside the stator 11 and it includes a rotor shaft 22 shaped like a hollow cylinder, a rotor core 23, a magnet 24 and a magnet cover 25 arranged coaxial with one another. The rack shaft 2 is inserted in the rotor shaft 22. The cylindrical rotor core 23 is mounted on the outer circumferential surface of the rotor shaft 22. On the outer circumferential surface of the rotor core 23, the magnet 24 having six poles structure is fixed.

As the magnet 24, a rare-earth magnet, for example, neodymium-iron magnet is used, which is small and provides high flux density. By the use of a rare-earth magnet for the magnet 24, the motor 1 can be miniaturized, as well as the inertia of the rotor 21 decreases, improving the feeling of steering. The magnet 24 is shaped like a ring, and has N poles and S poles arranged alternately in the circumferential direction. Note that, the magnet 24 may be replaced by a plurality of segment magnets. The magnet cover 25 is fitted on the outside of the magnet 24, even if the magnet 24 is broken, the motor 1 is prevented from being locked by the resulting fragments.

To the right side end of the housing 12 (FIG. 1), there is secured a housing 31 that is an aluminum die-cast product. A bearing 32 supporting the right end of the rotor 21 and a resolver 33 detecting the rotation of the rotor 21 are held in the housing 31. The resolver 33 comprises a resolver stator 34 secured to the housing 31 side and a resolver rotor 35 secured to the rotor 21 side. Around the resolver stator 34, a coil 36 having an exciting coil and a detecting coil is wound. The resolver rotor 35 secured to the rotor shaft 22 is arranged inside the resolver stator 34. The resolver rotor 35 is composed of many metal plates laid on one another, and has projections protruding in three directions.

As the rotor shaft 22 rotates, the resolver rotor 35 rotates inside the resolver stator 34. A high frequency signals is applied to the exciting coil of the resolver stator 34. As the projections approach and leave the detecting coil, a phase of the signal output from the detecting coil changes. By comparing the signal output from the detecting coil with a reference signal, the rotation position of the rotor 21 is detected. Based on the rotation position of the rotor 21 thus detected, the current supplied to the winding 14 is switched appropriately, as a result, the rotor 21 is driven and rotated.

To the left side end of the housing 12 (FIG. 1), there is secured a housing 41 that is an aluminum die-cast product. The housing 41 holds the ball-screw mechanism 3. The ball-screw mechanism 3 has a nut section 42, a screw section 43 provided at the outer circumferential surface of the rack shaft 2, and a number of balls 44 arranged between the nut section 42 and the screw section 43. The rack shaft 2 is supported by the nut section 42 in such a way that its rotary motion around the axis of rotation is restricted but it is reciprocated right and left direction as the nut section 42 is rotated.

The nut section 42 is fixed to the left end of the rotor shaft 22 and supported by an angular bearing 45 secured to the housing 41, and can rotate. The angular bearing 45 is secured, restricted in its axial motion, between bearing-holding rings 46a, 46b screwed into an opening formed in the housing 41 and a stepped section 47 formed in the housing 41. The relative axial movement of the nut section 42 and the angular bearing 45 is restricted by another bearing holder ring 48 screwed into the left end of the nut section 42 and another stepped section 49 formed on the outer peripheral wall of the nut section 42.

In the EPS having the motor 1 thus configured, the steering shaft is rotated when the steering wheel is operated, and the rack shaft 2 is moved in the direction corresponding to the sense of rotation of the steering shaft to carry out a steering operation. A steering torque sensor (not shown) is actuated by the operation, then, electric power is supplied from the battery to the winding 14 through the power supplying wires 15 in accordance with the detected torque. When the power is supplied to the winding 14, the motor 1 is activated and the rotor shaft 22 is thereby driven. As the rotor shaft 22 is so driven, the nut section 42, which is coupled to the rotor shaft 22, is rotated, the steering assist force is transmitted to the rack shaft 2 under the effect of the ball-screw mechanism 3. As a result, the movement of the rack shaft 2 is promoted and the steering power is assisted.

On the other hand, in such a motor for EPS, it is a problem how the magnetic load and the electric load should be distributed in order to hold the size of motor and obtain a high output when determining the specification items to satisfy required performance. The magnetic load is the sum of all motor magnetic fluxes, and the electric load is the sum of the number of ampere conductors, in motor magnetically loaded greatly, the proportion of the stator core 13 and the magnet 24 is large and generally the motor is enlarged. By contrast, any motor having large electrical load can be downsized, but the winding temperature is likely to rise. As the element of determining the distribution of the magnetic load and the electric load, there are the influence on the characteristics by the change of inertia, the influence on the cost by the amount of the magnet used, the influence on the assembling efficiency by small winding space, the influence on weight by the change of the iron amount and the like, it is necessary to consider various elements.

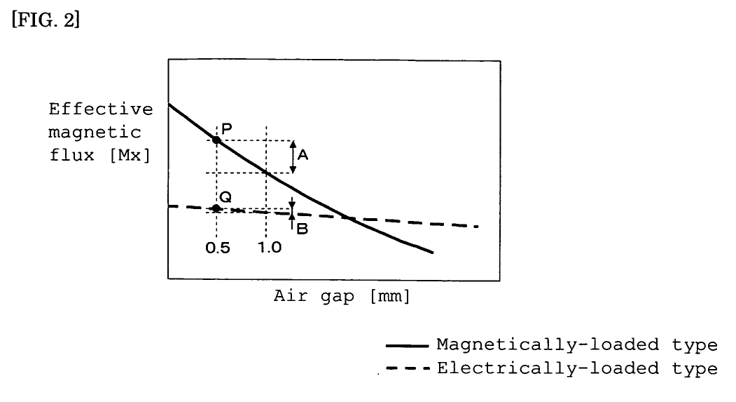

In addition to these elements, particularly a motor for EPS, it is necessary to consider the influence on the characteristics as important by the change of the air gap between the magnet 24 and the stator teeth, which results from the component tolerance or the assembling error. FIG. 2 is an explanatory diagram showing the relation between the air gap and the effective magnetic flux (magnetic flux amount contributing to the torque: magnetic flux emanated from the magnet 24 and returned thereto via the teeth) by comparing a magnetically loaded type motor with an electrically loaded type motor. As seen from FIG. 2, the magnetically loaded type motor more magnetically loaded than electrically loaded has more effective magnetic flux Max than the electrically loaded type motor more electrically loaded than magnetically loaded, at the same air gap (see points P and Q shown in FIG. 2). Hence, a motor become a high-torque type if the magnetically load distribution is enlarged and it is possible to increase the output.

As can be understood from FIGS. 2A and 2B, however, the effective magnetic flux changes more greatly with the air gap in the magnetically loaded type motor than in the electrically loaded type motor. Thus, if the air gap varies, the effective magnetic flux changes very much and the torque error or torque variation becomes large, even in the assembly tolerance, to increase cogging or torque ripple. Cogging and torque ripple may cause the EPS motor to degrade the feeling of steering, and are therefore undesirable. The cost of the magnetically loaded type motor is high because it needs a large amount of magnet that is expensive as magnetically load is large, further, the weight thereof is large because of the increase in the amount of iron used.

In short, the magnetically loaded type motor can generate a large torque, but the variation of the torque is large, by contrast, the electrically loaded type motor cannot generate a large torque, though the torque variation is little. In view of this, the inventors hereof conducted a study on a load distribution of the six-pole, nine-slot motor suitable for EPS considering the advantages and disadvantages of those type motors in order to obtain necessary torque and to reduce the torque variation to improve the feeling of steering under the severe dimensional restriction. The results of the study showed that it is possible to obtain a motor for EPS which can satisfy size, output, feeling of steering and cost, in a well-balanced manner, if the load ratio M, which is defined below, falls within a range of 100 to 300.

[Mathematic Formula 1]

$$M = \frac{2 P Φ}{\frac{ZI}{a}}$$

where P is the number of poles, Z is the number of effective conductors, a is half the number of parallel circuits, Φ is the effective magnetic flux per pole, and I is the effective value of rated phase-current.

In this case, Z, i.e., number of effective conductors, means the number of conductors that contribute to the torque. The number of effective conductors is product (S×T) of S, i.e., number of slots, and T, i.e., number of winding turns, for example, in a 10-slot, 6-turn motor, the number of conductors is 60 (=6×10). The number of effective conductors is a part for contributing to the torque, for example, in a three-phase motor, it is two-thirds (⅔) of the conductors. Hence, in the above mentioned example, Z=60×⅔=40. I, or effective value of rated phase-current, is the effective value of the rated motor current (maximum allowable current in the EPS) that flows for a specific phase (e.g., U phase in a three-phase motor). The number of parallel circuits “a” shows, for example in a three-phase motor, how many sets of circuit composed of a U-, V- and W-phase circuit.

According to the inventor's experiment, in a six-pole (P=6), nine-slot motor, it was possible to realize a motor which generated an output of 750 W, a cogging torque of 20 mNm or less when applied with a voltage of 12 V, though the outside diameter of motor 1 (i.e., outside diameter of the housing 12) was smaller than 100 mm, when M=130 (Φ=98069 (M×/pole), Z=108 (effective conductors), I=84 (Arms), and a=1. In this case, it is extremely difficult to hold the outside diameter of the motor to less than 85 mm, because of the outside diameter of the rack shaft etc., therefore, in the motor according to this invention, the outside diameter of the motor is set to 90 to 100 mm, preferably about 85 to 95 mm. The condition of 100≦M≦300, applied to this invention, proved to be effective, particularly to six-pole, nine-slot motors.

In a magnetically loaded type motor having M value exceeding 300, since the iron core is comparatively large, it becomes proportionally heavy and the magnet is proportionally large, therefore, the cost of the motor is high. In the nine-slot motor, since variation of the inside diameter thereof is large, size variation of the air gap becomes large and the undulation of torque increases to degrade the feeling of steering. By contrast, an electrically loaded type motor whose M value is less than 100 intends to generate heat because its winding has many turns, it is therefore necessary to consider insulation and a space factor of the winding in the slots and to take the cooling measures of the winding. Also, in the electrically loaded type motor, since the output depends on the power supplied, it may not be resistant to disturbance, the influence of control variation tends to come out and the motor tends to be a motor which is hard to control.

As mentioned above, the motor according to this invention exhibits optimal characteristics for use in the EPS, and it satisfies size, output, feeling of steering and cost, in a well-balanced manner. This small, high-output motor ultimately serves to save fuel in the vehicle. In addition, its rotor is small, decreasing the inertia and, hence, improving the feeling of steering. Furthermore, in the motor according to the invention, since appropriate parameters for the EPS are preset with respect to the load ratio M, which is one of the parameters that poses a problem in designing the motor structure, the designer only needs to determine the specification of each motor component in accordance with the corresponding parameter on the structure design. That is, the present invention provides design guidelines optimal for the EPS. An EPS motor can therefore be easily provided, which is smaller and can produce a high output, make smaller friction and lower torque ripple, and lower cost than the conventional EPS motors and it is possible to realize optimal design and to reduce the number of designing steps. Therefore, the cost of developing the product can be proportionally reduced, and the product cost can be also lowered.

The inventors conducted an experiment, which showed that the ratio of the magnetically loaded diameter φ1 with which the magnetically loaded section serves as the principal part (similar to the diameter of the rotor in this embodiment) to the electrically loaded diameter φ2 with which the electrically loaded section serves as the principal part (similar to the diameter of the stator core in this embodiment), i.e., φ1:φ2, should preferably be 1:2 to 1:2.5.

Needless to say, the present invention should not be limited to the embodiment described above, and may be variously modified within the scope not departing from the gist.

For example, the motor described above, in which M=130, is merely an example, motors of any other specifications can be manufactured.

1. A motor for use in an electric power steering apparatus, which is configured to be mounted on, and arranged coaxial with, a rack shaft linked to a steering control wheel, and supplies a steering assist force to the rack shaft, characterized in that
the load ratio (2PΦ/(ZI/a)) showing the ratio of the magnetic load (2PΦ) of the motor to the electric load (ZI/a) thereof is 100 to 300.

2. The motor for use in an electric power steering apparatus, according to claim 1, characterized in that
the motor is a brushless motor having six poles and nine slots.

3. The motor for use in an electric power steering apparatus, according to claim 1, characterized by comprising:
a stator having a housing, a stator core secured to an inner circumferential surface of the housing, and a winding wound around the stator core; and
a rotor having a hollow-cylindrical rotor shaft in which the rack shaft of the steering device is inserted, a hollow-cylindrical rotor core mounted on an outer circumferential surface of the rotor shaft, a magnet mounted on an outer circumferential surface of the rotor core, and a magnet cover fitted on the outside of said magnet.

4. The motor for use in an electric power steering apparatus, according to claim 3, characterized in that the housing has an outside diameter ranging from 85 mm to 100 mm.
